(19) United States
(12) Patent Application Publication
(10) Pub. No.: US 2025/0303380 A1
(43) Pub. Date: Oct. 2, 2025

(54) HIGH-EFFICIENCY METHANOL REFORMING HYDROGEN PRODUCTION DEVICE

(71) Applicants: Wang Fai Victor CHEUNG, Hong Kong (CN); Wang Fung Samuel CHEUNG, Hong Kong (CN); Bill LOH, Singapore (SG)

(72) Inventors: Wang Fai Victor CHEUNG, Hong Kong (CN); Wang Fung Samuel CHEUNG, Hong Kong (CN)

(73) Assignees: Wang Fai Victor CHEUNG, Hong Kong (CN); Wang Fung Samuel CHEUNG, Hong Kong (CN); Bill LOH, Singapore (SG)

(21) Appl. No.: 18/864,880

(22) PCT Filed: Nov. 27, 2023
(86) PCT No.: PCT/CN2023/134381

§ 371 Date: Nov. 11, 2024

(30) Foreign Application Priority Data
Dec. 7, 2022 (CN) 202211565891.6

(51) Int. Cl. B01J 8/06; C01B 3/32

(52) U.S. Cl. CPC B01J 8/065; B01J 8/067; C01B 3/323; B01J 2208/00061; B01J 2208/00256; B01J 2208/00398; B01J 2208/00415; B01J 2208/00548; B01J 2208/065; C01B 2203/0233; C01B 2203/0833; C01B 2203/1223; C01B 2203/1619; C01B 2203/1623; C01B 2203/1685; C01B 2203/169

(57) ABSTRACT

A high-efficiency methanol reforming hydrogen production device includes a housing, a reactor, a heat exchanger, a liquid supply pipe and an exhaust pipe. The housing includes an outer housing and an inner housing arranged inside the outer housing. A vacuum interlayer is arranged between the inner housing and the outer housing. The reactor is arranged in the inner housing. The heat exchanger is arranged at the front end of the housing and is filled with a heat exchange medium. One end of the liquid supply pipe is connected to a liquid inlet of the reactor, and the other end of the liquid supply pipe passes through the heat exchanger and is then exposed. One end of the exhaust pipe is connected to a gas outlet of the reactor, and the other end of the exhaust pipe passes through the heat exchanger and is then exposed.

### CROSS REFERENCE TO THE RELATED APPLICATIONS

This application is the national phase entry of International Application No. PCT/CN2023/134381, filed on Nov. 27, 2023, which is based upon and claims priority to Chinese Patent Application No. 202211565891.6, filed on Dec. 7, 2022, the entire contents of which are incorporated herein by reference.

### TECHNICAL FIELD

This application relates to the technical field of hydrogen production from methanol, in particular to a high-efficiency methanol reforming hydrogen production device.

### BACKGROUND

Methanol has a high mass hydrogen storage density, which is a solution to the bottleneck problem of storage and transportation in hydrogen energy applications. Generally speaking, there are three methods for producing hydrogen from methanol, i.e., steam reforming of methanol (SRM), oxidative methanol reforming (OMR) and partial oxidation of methanol (POM). Among them, the technology of steam reforming of methanol (SRM) is more mature, with a hydrogen yield of up to 75%. However, the current device for steam reforming of methanol (SRM) is large in size, time-consuming to start up, and energy-intensive, and therefore is not widely used in mobile vehicles. The hydrogen production process of steam reforming of methanol is thermodynamically a high-temperature, favorable endothermic reaction with an operating temperature of 250° C. Therefore, it consumes a large amount of energy when heated and still needs to be heated continuously during the reaction. When the hydrogen supply demand increases, the size of the device increases, and the amount of energy required for heating increases accordingly. The heating method of partial methanol steam reforming is to burn methanol for heating, which is difficult to control the temperature, and the consumption of methanol reduces the hydrogen production rate. The relatively high operating temperature and the presence of a vaporization unit cause a distributed methanol hydrogen production system to respond slowly under start-up conditions.

### SUMMARY

In view of above, the present application provides a high-efficiency methanol reforming hydrogen production device, which can solve the above problem.

In order to achieve the above object, the present application provides the following solutions.

A high-efficiency methanol reforming hydrogen production device includes a housing, a reactor, a heat exchanger, a liquid supply pipe and an exhaust pipe. The housing includes an outer housing and an inner housing disposed in the outer housing, and a vacuum interlayer is provided between the inner housing and the outer housing. The reactor is arranged in the inner housing. The heat exchanger is arranged at the front end of the housing and is filled with heat exchange medium. One end of the liquid supply pipe is connected to a liquid inlet of the reactor, and the other end of the liquid supply pipe passes through the heat exchanger and is then exposed. One end of the exhaust pipe is connected to a gas outlet of the reactor, and the other end of the exhaust pipe passes through the heat exchanger and is then exposed.

Further, the reactor includes an inner core, an outer core, a separation cylinder and a ceramic heating plate. The separation cylinder is arranged in a front-to-back direction. The inner core and the outer core are separated by a circumferential side of the separation cylinder, and a rear part of the inner core is in communication with the outer core. The separation cylinder is made of corrosion-resistant metal material, and the ceramic heating plate is arranged on the circumferential side of the separation cylinder.

Further, the ceramic heating plate is in the shape of a strip and is arranged in the front-to-back direction. There are a plurality of the ceramic heating plates which are uniformly distributed on the circumferential side of the separation cylinder.

Further, a first type of catalyst with high catalytic activity for methanol at a low temperature is placed in a front part of the inner core; a second type of catalyst with high catalytic activity for methanol at a high temperature is placed in a rear part of the inner core and the outer core; and a third type of catalyst with high activity for carbon monoxide is placed in a front part of the outer core.

Further, the reactor further includes a sprayer, and the sprayer is arranged in a front end of the inner core and is communicated with the liquid supply pipe.

Further, the reactor further includes a thermometer, and the thermometer is arranged in a front part of the inner core.

Further, a part of the liquid supply pipe located in the heat exchanger is distributed in a helical shape.

Further, a part of the exhaust pipe located in the heat exchanger is distributed in a helical shape.

Further, the heat exchange medium is heat-transfer oil.

Further, the high-efficiency methanol reforming hydrogen production device further includes a controller. A liquid inflowing port of the liquid supply pipe is connected to a methanol water feedstock pump, and a gas outflowing port of the exhaust pipe is connected to a gas flowmeter. The controller is electrically connected to the methanol water feedstock pump, the gas flowmeter, the ceramic heating plate and a thermometer, and the controller controls working state of the methanol water feedstock pump and the ceramic heating plate based on feedback information from the gas flowmeter and the thermometer.

This application has the following advantages.
1. Energy Saving: on the one hand, the reactor is disposed in the housing having a vacuum interlayer to reduce the heat loss of the reactor; and on the other hand, the hydrogen and carbon dioxide after the reaction have a high temperature (having waste heat energy), and the heat energy is transferred to the methanol water inside the liquid supply pipe through a heat exchanger to raise the temperature of the methanol water, i.e., waste heat is recycled. Energy saving is realized from these two aspects.
2. Fast Startup: by disposing the ceramic heating plate outside the separation cylinder and adopting electric heating instead of the existing methanol combustion heating, the temperature will rise faster, so the startup will take shorter time. The startup will be faster.
3. Intelligent Control: based on the feedback temperature information, the controller controls the feeding time and feeding amount of methanol water feedstock pump so as to make the heat absorption and heating in the reactor stable and balanced, and regulates the switch of ceramic heating plate so as to make the temperature in the reactor stable; and based on the feedback flow information and the required gas output, the controller controls the feeding time and feeding amount of methanol water feedstock pump, and regulates the switch of the ceramic heating plate, so as to maintain the required gas output.

### BRIEF DESCRIPTION OF THE DRAWINGS

In order to more clearly illustrate the technical solutions in the embodiments of the present application or in the prior art, the accompanying drawings to be used in the description of the embodiments or prior art will be briefly described below. Obviously, the accompanying drawings in the following description are merely exemplary, and other drawings may be obtained on the basis of the provided accompanying drawings by those skilled in the art without creative efforts.

The structure, proportion, size and the like depicted in this specification are only used to match the content of the specification, for those skilled in the art to understand and read, but is not intended to limit the condition for implementation of the application. Thus, there is no technical significance, and any structural modification, change in proportionality or adjustment in size that does not affect the effect and purpose of this application shall remain within the scope of the technical content disclosed in this application.

FIG. 1 is a schematic structural view of a high-efficiency methanol reforming hydrogen production device provided according to an embodiment of the present application;

FIG. 2 is a sectional view of a high-efficiency methanol reforming hydrogen production device provided according to an embodiment of the present application;

FIG. 3 is a cross-section view of a high-efficiency methanol reforming hydrogen production device provided according to an embodiment of the present application; and

FIG. 4 is a view showing the working principle of a high-efficiency methanol reforming hydrogen production device provided according to an embodiment of the present application.

Reference numerals in the Drawings:

| | | |
|---|---|---|
| 1- outer housing, | 2- inner housing, | 3-controller, |
| 4- vacuum interlayer, | 5- reactor, | 6- heat exchanger, |
| 7-sprayer, | 8-inner core, | 9-outer core, |
| 10-thermometer, | 11-separation cylinder, | 12-ceramic heating |
| | | plate, |
| 13-first type of | 14-second type of | 15- third type of |
| catalyst, | catalyst, | catalyst, |
| 16- liquid supply | 16a-liquid inflowing | 16b-liquid |
| pipe, | port, | outflowing port, |
| 17a-gas inflowing port, | 17b-gas outflowing port | |

### DETAILED DESCRIPTION OF THE EMBODIMENTS

Hereinafter, the implementation of the present invention will be described by specific embodiments. Those skilled in the art can easily understand other advantages and functions of the present invention on the basis of disclosure of this specification. It is obvious that the described embodiments are a part of the embodiments of the present invention and not all of the embodiments. Based on the embodiments of the present application, all other embodiments obtained by those skilled in the art without creative efforts are within the scope of protection of the present invention.

The terms such as “upper”, “lower”, “left”, “right”, “middle” used in this specification are only for the purpose of clarity and are not intended to limit the scope of the present invention, and changes or adjustments in the relative relationships thereof shall be considered to be within the scope of the present invention in the absence of substantial changes in the technical content.

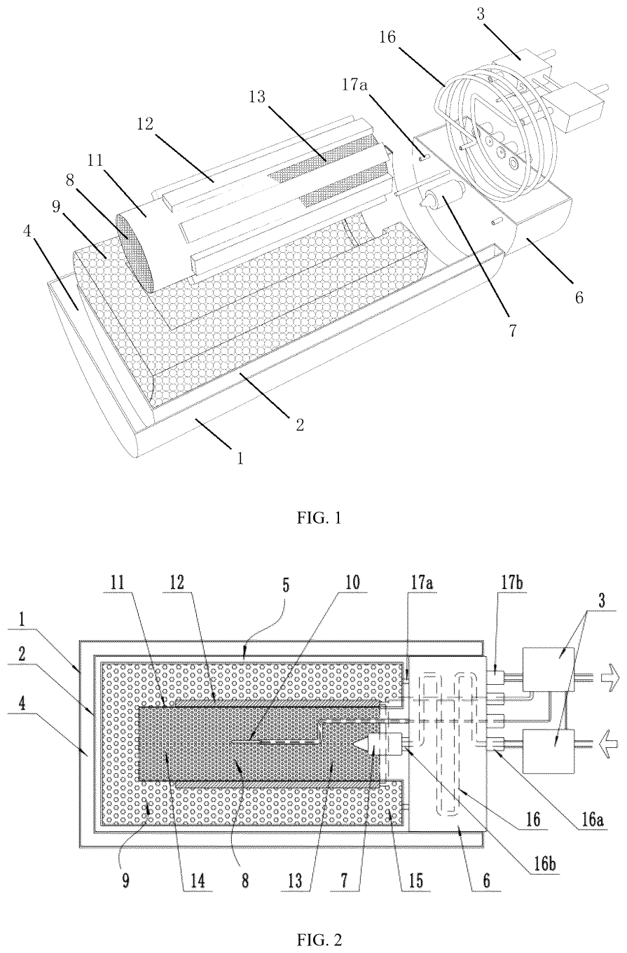

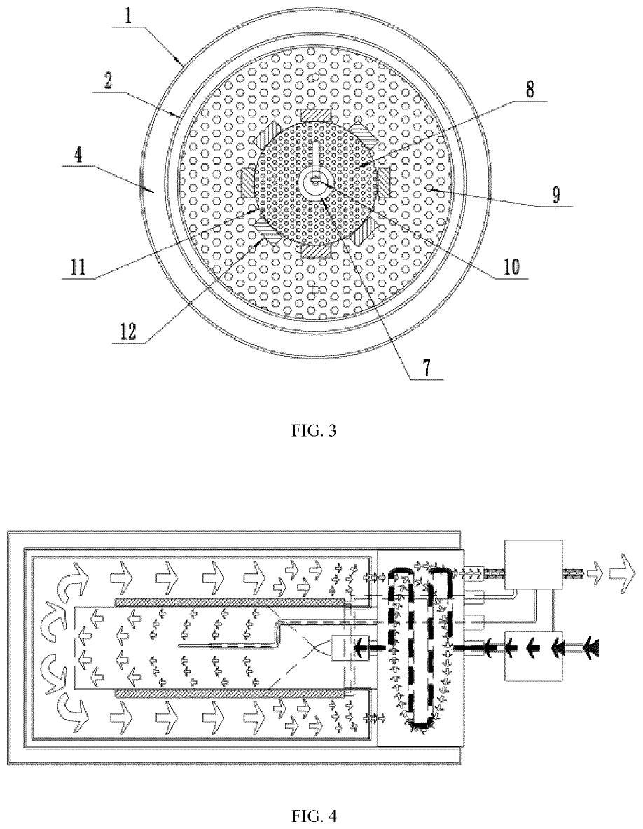

As shown in FIGS. 1 to 4, the present embodiment provides a high-efficiency methanol reforming hydrogen production device, including a housing, a reactor 5, a heat exchanger 6, a liquid supply pipe 16 and an exhaust pipe. The housing is a cylindrical housing opened at the front end and closed at other parts, and includes an outer housing 1 and an inner housing 2 disposed within the housing 1. A vacuum interlayer 4 is provided between the inner housing 2 and the outer housing 1. The reactor 5 is disposed within the inner housing 2, and is configured to convert methanol water fed through the liquid supply pipe 16 into hydrogen and carbon dioxide under the action of a catalyst. In this process, the reactor 5 has a high temperature (generally at 250° C.) and therefore the exhaust gas also has high temperature properties. The heat exchanger 6 is provided in a front opening of the housing, and is filled with a heat exchange medium. The liquid outflowing port 16b of the liquid supply pipe 16 is connected to the liquid inlet of the reactor 5. The liquid inflowing port 16a of the liquid supply pipe 16 passes through the heat exchanger 6 and is exposed from the front end of the heat exchanger 6, and the exposed liquid inflowing port 16a is connected to the methanol water feedstock pump. The gas inflowing port 17a of the exhaust pipe is connected to the gas outlet of the reactor 5. The gas outflowing port 17b of the exhaust pipe passes through the heat exchanger 6 and is then exposed from the front end of the heat exchanger 6, and the exposed gas outflowing port 17b is connected in series with a gas flow meter. In this embodiment, there is a plurality of exhaust pipes, and the gas outflowing ports 17b of the plurality of exhaust pipes are merged and then are connected to the gas flow meter. It is to be noted that the exhaust pipe may be continuous (meaning that the gas cannot be in direct contact with the heat exchange medium) or interrupted (meaning that the gas may be in direct contact with the heat exchange medium) within the heat exchanger 6. On the one hand, the reactor 5 is arranged in a housing having a vacuum interlayer 4, which reduces the heat energy loss of the reactor 5; and on the other hand, the hydrogen and carbon dioxide generated from the reaction have a high temperature (having waste heat energy). The heat energy is transferred to the methanol water inside the liquid supply pipe 16 through the heat exchanger 6, which raises the temperature of the methanol water, i.e., recovers the waste heat. Energy saving is realized in these two aspects. When the device is in operation, the methanol water enters the reactor 5, and the heat exchanger 6 can heat the methanol water up to approximately 180° C., so that the reactor 5 does not cool down significantly due to very low temperature of the feed (the normal operating temperature of the reactor 5 is at 250° C.). The thermal reaction part (reactor 5) and the heat recovery part (heat exchanger 6) involved in the entire device are operated under vacuum, so that the endothermic reaction of methanol reforming can be accomplished with low energy consumption.

The reactor 5 includes an inner core 8, an outer core 9, a sprayer 7, a separation cylinder 11, a ceramic heating plate 12 and a thermometer 10. The outer core 9 surrounds the inner core 8. The separation cylinder 11 is provided in a front-to-back direction. The separation cylinder 11 separates the inner core 8 from the outer core 9 at a circumferential side, and a rear portion of the inner core 8 is in communication with the outer core 9. The sprayer 7 is provided in the inner core 8 at the front end, and is communicated with the liquid outflowing port 16b of the liquid supply pipe 16. Methanol water will be ejected from the sprayer 7 at the front end of the inner core 8. Due to the high temperature and high injection pressure, the ejected methanol water has been thoroughly vaporized to form gaseous methanol water, which needs to continuously absorb heat because of the relatively low temperature (i.e., 180° C. which is lower than 250° C.) of the methanol water. As a result, the temperature of the front portion of the inner core 8 is reduced. Thus, a first type of catalyst 13 with high catalytic activity for methanol at low temperatures is placed in the front of the inner core 8 so as to improve the catalytic effect and the high hydrogen production rate. After the methanol water absorbs heat, the temperature rises to the ideal temperature (250° C.). At this time, the heated methanol water comes to the rear part of the inner core 8. Thus, a second type of catalyst 14 with high catalytic activity for methanol at high temperature is placed at the rear part of the inner core 8 and the outer core 9 so as to improve the catalytic effect and the high rate of hydrogen production. The front part of the outer core 9 is communicated with the exhaust pipe, where the gas is collected. The gas includes not only hydrogen and carbon dioxide, but also a small amount of carbon monoxide. Thus, a third type of catalyst 15 with high activity for carbon monoxide is placed in the front part of the outer core 9 so as to reduce the content of carbon monoxide. The vaporized methanol water will first pass through the catalyst in the inner core 8 to the bottom of the inner core 8 and further to the bottom of the outer core 9, and then pass through the catalyst in the outer core 9 to the front of the outer core 9. Such a design increases the period of time for which the methanol water contacts with the catalysts, making the methanol reforming reaction more effective. The ceramic heating plate 12 is arranged on the circumferential side of the separation cylinder 11. The separation cylinder 11 is made of corrosion-resistant metal material. The ceramic heating plate 12, when energized and heated, can heat both the inner core 8 and the outer core 9. The ceramic heating plate 12 is in the shape of a strip and is arranged in the front-to-back direction. There may be a plurality of ceramic heating plates 12, which are uniformly distributed on the circumferential side of the separation cylinder 11; so that the catalysts in the inner core 8 and the outer core 9 can be heated evenly, and the temperature of the methanol reforming reaction can be accurately maintained. By providing the ceramic heating plate 12 outside the separation cylinder 11, the existing heating with methanol combustion is replaced by electric heating, which warms up faster so that the start-up takes less time, i.e. is faster. Generally, the power cable of the ceramic heating plate 12 is routed in a power tube running through the heat exchanger 6, and is connected to a controller 3, so that the ceramic heating plate 12 works under the control of the controller 3. The thermometer 10 is provided in a front portion of the inner core 8 to measure the temperature of the reactor 5 in real time. In this embodiment, the liquid supply pipe 16, the exhaust pipe and the power tube are all made of high temperature resistant material.

Three types of catalysts with different characteristics are used in the reactor 5 to match the reaction processes at different states of the gasified methanol water. Starting from the front end of the inner core 8, when the gasified methanol water enters the reactor 5, the temperature is relatively low, about 180° C. Therefore, an appropriate amount of the first type of catalyst 13, which has high activity at low temperature, is placed at the front end of the inner core 8. Since this type of catalyst is costly, its use in moderation reduces waste and increases cost-effectiveness. At this stage or location, a portion of the methanol water that has not been brought to the elevated temperature is first reformed. When the system begins to operate, it must be heated to the desired temperature for the methanol reforming reaction using a heating device, e.g., a ceramic heating plate 12. The low-temperature, high-activity catalyst shortens the time to start the methanol reforming reaction, fully utilizing the time before the hydrogen-rich gas is output. When a portion of the gasified methanol water is being reformed, the unreformed methanol water is brought up to the most efficient reforming temperature (about 250° C.). Therefore, the catalysts in the inner and outer cores 9 are mostly the second type of catalyst 14 with higher activity at the higher temperature, so that all of the methanol water entering the reactor 5 can be catalyzed and reformed into hydrogen-rich gas. During the catalytic process, a small amount of carbon monoxide is generated. Because some third type catalysts 15, which have activity for carbon monoxide, are appropriately placed at the front part of the outer core 9 near the exhaust pipe, the carbon monoxide in the hydrogen-rich gas may be removed.

Optionally, the portion of the liquid supply pipe 16 located in the heat exchanger 6 is distributed in a helical shape, so as to increase the heat exchange area with the heat exchange medium, which is conducive to the improvement of the waste heat utilization rate. Optionally, the portion of the exhaust pipe disposed within the heat exchanger 6 is distributed in a helical shape so as to increase the heat exchange area with the heat exchange medium, which is conducive to the improvement of the waste heat utilization rate. Optionally, the exhaust pipe ends in the heat exchanger 6, that is, the exhaust pipe is very short. The gas is allowed to flow freely inside the heat exchanger 6, so that the gas is in direct contact with the heat exchanger medium, achieving a higher heat exchanging efficiency. Accordingly, a shorter exhaust pipe is also provided at the front end of the heat exchanger 6, so as to be connected to a gas flowmeter, a hydrogen storage device, or a hydrogen-using device. Optionally, the heat exchange medium is heat-transfer oil. The above optional embodiments are only illustrative and not intended to limit the implementation of other alternative technical solutions.

In this embodiment, the high-efficiency methanol reforming hydrogen production device further includes a controller 3. The liquid inflowing port 16a of the liquid supply pipe 16 is connected to a methanol water feedstock pump, and the gas outflowing port of the exhaust pipe is connected to a gas flowmeter. The controller 3 is electrically connected to the methanol water feedstock pump, the gas flowmeter, the ceramic heating plate 12 and a thermometer 10. The controller 3 controls the working state of the methanol water feedstock pump and the ceramic heating plate 12 based on feedback information from the gas flowmeter and the thermometer 10.

Based on the feedback temperature information, the controller 3 controls the feeding time and the feeding amount of the methanol water feedstock pump to stabilize and balance heat absorption and heating in the reactor 5, and controls a switch of the ceramic heating plate 12 to stabilize the temperature in the reactor 5. Based on the feedback flow rate information and the desired gas output, the controller 3 controls the feeding time and the feeding amount of the methanol water feedstock pump, and controls the switch of the ceramic heating plate 12 to maintain the required gas output. As such, the intelligent control of the high-efficiency methanol reforming hydrogen production device is realized. Optionally, the controller 3 adopts a PLC circuit board, etc.

With respect to the energy consumption of the methanol reforming reaction, the controller 3 adjusts the temperature of the device and the injection volume of methanol water according to the reaction conditions in the reactor 5. Since the preferred temperature for the efficiency of the methanol water reforming reaction is in a range of 250° C. to 270° C., the controller 3 needs to make adjustments according to the following conditions.

According to a set gas output of the system:
1. when the gas output is more than the set gas output, the controller 3 will reduce the injection amount of methanol water and turn off all of the ceramic heating plates 12, so that the temperature inside the reactor 5 will be gradually decreased and the reaction speed will be slowed down, reducing the gas output to the set level.
2, when the gas output is less than the set gas output, the controller 3 will increase the injection amount of methanol water, which in turn causes rapid decrease of the temperature inside the reactor 5, so the controller 3 needs to adjust the temperature of the ceramic heating plate 12 to be high so as to accelerate the methanol water reforming reaction, increasing the gas output to the set level.
3, when the reactor 5 starts to operate, the ceramic heating plate 12 needs to be heated at full speed so that the reactor 5 reaches the desired temperature of the methanol reforming reaction in a short time. If the injection amount of methanol water is low, the reactor 5 may be overheated; if the injection amount of methanol water is excessive, the catalyst in the reactor 5 will be coated with methanol water molecules that cannot be reformed, which slows down the speed of heating and also consumes more energy. Therefore, the controller 3 needs to control the number of times and amount of injection of methanol according to the real-time heating rate. When the temperature rises to the better temperature of the methanol reforming reaction (250° C. to 270° C.), the controller 3 needs to control the ceramic heating plate 12 in the most energy-saving state, so that the output of the methanol reforming reaction and the temperature control to reach a balance, achieving the effect of high-efficiency methanol reforming hydrogen production.

Although the present invention has been illustrated in detail above by a general description and specific embodiments, some modifications or improvements may be made on the basis of the present invention, which will be obvious to those skilled in the art. Therefore, these modifications or improvements made without departing from the spirit of the present invention are within the scope of protection of the present invention.

What is claimed is:

1. A high-efficiency methanol reforming hydrogen production device, comprising a housing, a reactor, a heat exchanger, a liquid supply pipe, and an exhaust pipe, wherein the housing comprises an outer housing and an inner housing disposed in the outer housing, a vacuum interlayer is provided between the inner housing and the outer housing, the reactor is arranged in the inner housing, the heat exchanger is arranged at a front end of the housing and is filled with a heat exchange medium, a first end of the liquid supply pipe is connected to a liquid inlet of the reactor, and a second end of the liquid supply pipe passes through the heat exchanger and is then exposed, and a first end of the exhaust pipe is connected to a gas outlet of the reactor, and a second end of the exhaust pipe passes through the heat exchanger and is then exposed.

2. The high-efficiency methanol reforming hydrogen production device according to claim 1, wherein the reactor comprises an inner core, an outer core, a separation cylinder, and a ceramic heating plate, wherein the separation cylinder is arranged in a front-to-back direction, the inner core and the outer core are separated by a circumferential side of the separation cylinder, a rear part of the inner core is in communication with the outer core, the separation cylinder is made of a corrosion-resistant metal material, and the ceramic heating plate is arranged on the circumferential side of the separation cylinder.

3. The high-efficiency methanol reforming hydrogen production device according to claim 2, wherein the ceramic heating plate is in a shape of a strip and is arranged in the front-to-back direction, and a plurality of ceramic heating plates are provided and uniformly distributed on the circumferential side of the separation cylinder.

4. The high-efficiency methanol reforming hydrogen production device according to claim 2, wherein a first type of catalyst with high catalytic activity for methanol at a low temperature is placed in a front part of the inner core; a second type of catalyst with high catalytic activity for the methanol at a high temperature is placed in the rear part of the inner core and the outer core; and a third type of catalyst with high activity for carbon monoxide is placed in a front part of the outer core.

5. The high-efficiency methanol reforming hydrogen production device according to claim 2, wherein the reactor further comprises a sprayer, and the sprayer is arranged in a front end of the inner core and is communicated with the liquid supply pipe.

6. The high-efficiency methanol reforming hydrogen production device according to claim 2, wherein the reactor further comprises a thermometer, and the thermometer is arranged in a front part of the inner core.

7. The high-efficiency methanol reforming hydrogen production device according to claim 1, wherein a part of the liquid supply pipe is located in the heat exchanger and distributed in a helical shape.

8. The high-efficiency methanol reforming hydrogen production device according to claim 1, wherein a part of the exhaust pipe is located in the heat exchanger and distributed in a helical shape.

9. The high-efficiency methanol reforming hydrogen production device according to claim 1, wherein the heat exchange medium is heat-transfer oil.

10. The high-efficiency methanol reforming hydrogen production device according to claim 1, further comprising a controller, wherein a liquid inflowing port of the liquid supply pipe is connected to a methanol water feedstock pump, and a gas outflowing port of the exhaust pipe is connected to a gas flowmeter, the controller is electrically connected to the methanol water feedstock pump, the gas flowmeter, a ceramic heating plate, and a thermometer, and the controller controls a working state of the methanol water feedstock pump and the ceramic heating plate based on feedback information from the gas flowmeter and the thermometer.

11. The high-efficiency methanol reforming hydrogen production device according to claim 2, further comprising a controller, wherein a liquid inflowing port of the liquid supply pipe is connected to a methanol water feedstock pump, and a gas outflowing port of the exhaust pipe is connected to a gas flowmeter, the controller is electrically connected to the methanol water feedstock pump, the gas flowmeter, the ceramic heating plate, and a thermometer, and the controller controls a working state of the methanol water feedstock pump and the ceramic heating plate based on feedback information from the gas flowmeter and the thermometer.

12. The high-efficiency methanol reforming hydrogen production device according to claim 3, further comprising a controller, wherein a liquid inflowing port of the liquid supply pipe is connected to a methanol water feedstock pump, and a gas outflowing port of the exhaust pipe is connected to a gas flowmeter, the controller is electrically connected to the methanol water feedstock pump, the gas flowmeter, the ceramic heating plate, and a thermometer, and the controller controls a working state of the methanol water feedstock pump and the ceramic heating plate based on feedback information from the gas flowmeter and the thermometer.

13. The high-efficiency methanol reforming hydrogen production device according to claim 4, further comprising a controller, wherein a liquid inflowing port of the liquid supply pipe is connected to a methanol water feedstock pump, and a gas outflowing port of the exhaust pipe is connected to a gas flowmeter, the controller is electrically connected to the methanol water feedstock pump, the gas flowmeter, the ceramic heating plate, and a thermometer, and the controller controls a working state of the methanol water feedstock pump and the ceramic heating plate based on feedback information from the gas flowmeter and the thermometer.

14. The high-efficiency methanol reforming hydrogen production device according to claim 5, further comprising a controller, wherein a liquid inflowing port of the liquid supply pipe is connected to a methanol water feedstock pump, and a gas outflowing port of the exhaust pipe is connected to a gas flowmeter, the controller is electrically connected to the methanol water feedstock pump, the gas flowmeter, the ceramic heating plate, and a thermometer, and the controller controls a working state of the methanol water feedstock pump and the ceramic heating plate based on feedback information from the gas flowmeter and the thermometer.

15. The high-efficiency methanol reforming hydrogen production device according to claim 6, further comprising a controller, wherein a liquid inflowing port of the liquid supply pipe is connected to a methanol water feedstock pump, and a gas outflowing port of the exhaust pipe is connected to a gas flowmeter, the controller is electrically connected to the methanol water feedstock pump, the gas flowmeter, the ceramic heating plate, and the thermometer, and the controller controls a working state of the methanol water feedstock pump and the ceramic heating plate based on feedback information from the gas flowmeter and the thermometer.

16. The high-efficiency methanol reforming hydrogen production device according to claim 7, further comprising a controller, wherein a liquid inflowing port of the liquid supply pipe is connected to a methanol water feedstock pump, and a gas outflowing port of the exhaust pipe is connected to a gas flowmeter, the controller is electrically connected to the methanol water feedstock pump, the gas flowmeter, a ceramic heating plate, and a thermometer, and the controller controls a working state of the methanol water feedstock pump and the ceramic heating plate based on feedback information from the gas flowmeter and the thermometer.

17. The high-efficiency methanol reforming hydrogen production device according to claim 8, further comprising a controller, wherein a liquid inflowing port of the liquid supply pipe is connected to a methanol water feedstock pump, and a gas outflowing port of the exhaust pipe is connected to a gas flowmeter, the controller is electrically connected to the methanol water feedstock pump, the gas flowmeter, a ceramic heating plate, and a thermometer, and the controller controls a working state of the methanol water feedstock pump and the ceramic heating plate based on feedback information from the gas flowmeter and the thermometer.

18. The high-efficiency methanol reforming hydrogen production device according to claim 9, further comprising a controller, wherein a liquid inflowing port of the liquid supply pipe is connected to a methanol water feedstock pump, and a gas outflowing port of the exhaust pipe is connected to a gas flowmeter, the controller is electrically connected to the methanol water feedstock pump, the gas flowmeter, a ceramic heating plate, and a thermometer, and the controller controls a working state of the methanol water feedstock pump and the ceramic heating plate based on feedback information from the gas flowmeter and the thermometer.
